(19) United States
(12) Patent Application Publication
(10) Pub. No.: US 2014/0038686 A1
(43) Pub. Date: Feb. 6, 2014

(54) METHOD OF CONDUCTING AN OPT-IN SWEEPSTAKES

(71) Applicant: Sidney Hardman, Muskogee, OK (US)

(72) Inventor: Sidney Hardman, Muskogee, OK (US)

(21) Appl. No.: 13/958,129

(22) Filed: Aug. 2, 2013

Related U.S. Application Data
(60) Provisional application No. 61/678,923, filed on Aug. 2, 2012.

(51) Int. Cl. G07F 17/32

(52) U.S. Cl. CPC G07F 17/329
USPC 463/17

(57) ABSTRACT

According to an embodiment, there is provided a method of increasing participation in lotteries and/or sweepstakes or the like wherein users are given the option of adding some incremental amount to a bill or invoice that the user is required to pay, with the additional amount being the cost of entering a lottery or sweepstakes. In some embodiments, a statement that is sent to the user will contain a check-box or other field that a participant can use to indicate a willingness to enter to participate in the lottery. In some embodiments, the additional amount will be $1.00 up to $3.00. Since the user is obligated to pay the bill or statement anyway, adding an additional amount will not inconvenience the user and, additionally, will preferably be sized so that it will not represent a hardship to most customers.

### CROSS REFERENCE TO RELATED APPLICATIONS

This application claims the benefit of U.S. Provisional Patent Application Ser. No. 61/678,923 filed on Aug. 2, 2012, and incorporates said provisional application by reference into this document as if fully set out at this point.

### FIELD OF THE INVENTION

The present invention relates generally to methods of conducting a sweepstakes and, more specifically, to methods for combining payment of an invoice with entry into a sweepstakes. The process of combining a monthly bill or invoice receipt with a no-loss advantage will revolutionize the sweepstakes/lottery industry with the potential to greatly increase revenue to whatever business it is applied.

### BACKGROUND OF THE INVENTION

Lotteries and sweepstakes are commonplace and have broad support and participation. Often a state government controls the lottery and some portion of the profits is earmarked for a charity, public education, etc.

The standard model in conventional lotteries involves a participant visiting a convenience or other store to purchase a ticket. The user may, in some cases, be able to select a numerical combination that will become the user's entry into the lottery or sweepstakes. In other instances, the user will be able to request (or be required to receive) a randomly generated numerical entry. In either case, the winner will be determined by a randomized drawing and the user will compare his or her ticket against the published winning numerical combination(s) to determine whether or not a particular ticket is a winner.

However, one negative aspect of lotteries or sweepstakes systems as they are conventionally implemented is that they typically require a user to pay a visit to a convenience store, gasoline station, or other storefront in order to participate. Needless to say, many individuals who might otherwise have an interest in participating do not do so because of the inconvenience of deviating to such a location. As a consequence, the participation rate is lower than it might be otherwise.

Thus, what is needed is a more convenient method of conducting a lottery or sweepstakes that does not suffer from the disadvantages of the prior art. Further, it would be desirable if this system simultaneously inspired consumers to pay on time and pay more on their bill. Obviously, a new way to make the public feel appreciated would be welcomed.

Heretofore, as is well known in the lottery and sweepstakes industries, there has been a need for an invention to address and solve the disadvantages of prior art devices. Accordingly it should now be recognized, as was recognized by the present inventors, that there exists, and has existed for some time, a very real need for a system and method that would address and solve the above-described problems.

Before proceeding to a description of the present invention, however, it should be noted and remembered that the description of the invention which follows, together with the accompanying drawings, should not be construed as limiting the invention to the examples (or preferred embodiments) shown and described. This is so because those skilled in the art to which the invention pertains will be able to devise other forms of the invention within the ambit of the appended claims.

### SUMMARY OF THE INVENTION

According to some embodiments, there is provided a method of increasing participation in lotteries and/or sweepstakes or the like wherein users are given the option of adding some incremental amount to a bill or invoice that the user is already required to pay, with the additional amount being the cost of entering the lottery or sweepstakes. In some embodiments, a statement that is sent to the user will contain a check-box or other field that a participant can use to indicate a willingness to enter to participate in the lottery. In some embodiments, the additional amount will be $1.00 up to $3.00. Since the user is obligated to pay the bill or statement anyway, adding an additional amount will not inconvenience the user and, additionally, will preferably be sized so that it will not represent a hardship to most customers.

In an embodiment, the entity (e.g., company or corporation) that will conduct sweepstakes or lottery should return the entire (or a substantial portion) of the monies collected for that purpose (and not otherwise awarded as prizes, allocated to overhead, etc.) to the consumer so the consumer can apply the credit towards a future bill. Said another way, if the customer participates for each of twelve months and wins nothing during that time, some percentage of the, say, $12 played by the customer should be returned to that individual. That is, rather than the sponsoring entity receiving a benefit of this system, the profits therefrom should be returned to the customers in the form of a credit voucher after, of course, allowing for deduction of prizes awarded, overhead costs, administration costs, etc. In some embodiments each customer might receive 50% or more the amounts tendered returned to them at the end of the year as a rebate or credit against the amount owed to the sponsoring entity. In some variations, the consumer will have approximately six (6) months from date of issue to cash the credit voucher.

The sweepstakes winner will be able to use the funds for any purpose, but in some embodiments the winner will be able to take the winnings in the form of scholarships and/or payment on existing student loans, etc. Also, it should be noted that this approach will have the desirable consequence of encouraging more people to pay their bills, purchase homes, and spend more because they know they will get at least a portion of the lottery payments back in credit.

The foregoing has outlined in broad terms the more important features of the invention disclosed herein so that the detailed description that follows may be more clearly understood, and so that the contribution of the instant inventors to the art may be better appreciated. The instant invention is not limited in its application to the details of the construction and to the arrangements of the components set forth in the following description or illustrated in the drawings. Rather the invention is capable of other embodiments and of being practiced and carried out in various other ways not specifically enumerated herein. Additionally, the disclosure that follows is intended to apply to all alternatives, modifications and equivalents as may be included within the spirit and the scope of the invention as defined by the appended claims. Such as when buying any product or service, including those by companies and employees. Further, it should be understood that the phraseology and terminology employed herein are for the purpose of description and should not be regarded as limiting, unless the specification specifically so limits the invention.

### BRIEF DESCRIPTION OF THE DRAWINGS

Other objects and advantages of the invention will become apparent upon reading the following detailed description and upon reference to the drawings in which:

FIG. 1 contains an embodiment of the invention.

### DETAILED DESCRIPTION

According to a first aspect of the instant invention, there is provided a system and method for allowing a user to conveniently enter a lottery, sweepstakes, and the like. In brief, the instant invention is designed to allow a user to conveniently enter such a lottery or sweepstakes by adding an incremental amount to a debt that is already owed. In some embodiments, a user will tender payment for an indebtedness that is already owed and simultaneously indicate that an additional amount, e.g., $1.00 or a similar small payment, will be added to the user's payment with the incremental amount being the entry fee for the lottery or sweepstakes. In some embodiments, the obligation will be one that is incurred monthly, e.g., a phone bill, a water bill, an electric bill, etc.

By way of example and not by limitation, in some embodiments, a company such as a phone company will transmit a monthly statement or bill to a user. In that scenario, an integral part of the statement will be a field (e.g., a check box) that provides a mechanism that allows the user to opt in to participation in a lottery or sweepstakes. Additional explanatory text on the monthly statement will explain that by placing indicia within the field provided, the user will be obligated to pay an additional amount above that already owed. In some embodiments, the additional amount will be $1.00 or more, an amount which is not likely to seriously financially impact most customers. Note that, in the case of regularly paid bills (e.g., phone bill, gas bill, electrical bill, satellite TV bill, cable TV bill, etc.), the user will be given an opportunity every month to participate or not. Additionally, in some embodiments, e.g., where the bill is paid online, the user might be asked to indicate a willingness to participate by means of an on screen check box, radio button, or similar field. Further, in some instances the user might be allowed to opt-in with the understanding that participation will continue until the user specifically opts-out in a similar or different fashion to the methodology used to opt in. Those of ordinary skill in the art will readily appreciate that there are many ways that might be provided for a user to signify a willingness to participate.

If the user elects to participate, he or she will be expected to pay the amount of the bill plus the incremental amount designated for the lottery. In some embodiments, the user's customer ID will then be entered into a drawing for some amount of money (e.g., $50,000 or more). As a specific example, if the lottery or sweepstakes is being offered by a phone company, the user's phone number could become the number that is compared against the winning/randomly drawn number when the lottery is conducted by the phone company. In other embodiments, the user's customer number, ID number, etc., will become the lottery number and be eligible for whatever the prize might be, or the patron could choose a number or letter combination. Finally, in some embodiments a standard lottery might be conducted where random numbers are drawn. In such an instance, it is possible that there will be no winner in a given day, week, month, year, etc. In other embodiments, participants will be entered into a lottery that draws names (or customer IDs, etc.) from a list of those who have entered, thereby assuring that there will be a winner each month or time (e.g., twice a month, six times or more a year etc.) that the drawing is conducted. Although, both the lottery and sweepstakes have their benefits, it will ultimately be up to that company or entity to decide if it is called one or the other.

The host company should have no difficulty contacting winners of the sweepstakes because the contact information is already available to that company as part of the winner's billing information. In some embodiments, all credit vouchers will need to be used within six (6) months of issue date.

In some embodiments, a user will be able to opt in once at the start of every month, or once the consumer contracts business with one or more companies, and have each month's bill automatically incremented by the amount required to participate so that the user does not have to respond each time a bill is received. In that instance, the increment to the bill will automatically be added without further input from the user until a contrary instruction is received. Preferably, though, the user will be required to affirm at least once a month that he or she wishes to participate in the next lottery or sweepstakes.

In some embodiments, the prize will be some amount of cash. In other embodiments, the prize might be an amount of money that is to be provided to a college of the winner's choice in the event that the winner wishes to use the proceeds to fund the education of him or herself, or a dependent. In other instances, the winning amount might be applied to a paid-up life insurance or other insurance policy. In still other embodiments, the winnings might be applied against the debt owed by the user and/or credited against future bills (e.g., in some embodiments a lower level prize might be $1000 applied against the winner's phone bills going forward). In general, it is anticipated that in some cases the amount awarded will be in the form of cash that could be utilized for any purpose.

In still other embodiments, multiple companies will cooperate to conduct the lottery or sweepstakes. For example, the phone company, insurance companies, Western Union and the gas, water, or electric companies might cooperate to have a larger lottery. In this instance, the user might be permitted to enter multiple lotteries from a single bill (e.g., the phone bill might also contain fields for entering gas, electric, or other lotteries). In some instances, the lottery or sweepstakes will be entered via the credit card company that handles, for example, automatic bill payment. Additionally, in some embodiments, the credit card company itself will be the entity that conducts the lottery/sweepstakes.

In still other embodiments, Wal-Mart or other large retail chains might similarly offer the option to participate in a lottery on each sale. In such instances, the customer's sales receipt could become the lottery entry ticket and, at the time of purchase, the customer will pay some incremental amount above that shown on the register for the purchase in order to enter the lottery. In such an instance, the user's sales receipt could be used as a lottery ticket. Typically, such receipts also include a unique identifying code on them which then could become the number that is compared with the winning lottery number that is subsequently drawn.

In some embodiments, the drawings will be held once a month and the winner notified subsequently. In other embodiments, the prize might be $50,000.00, either in cash, college tuition, paid-up life insurance, etc. Obviously, the choice of a prize could influence participation rate. For example, if the only prize were college tuition, that would tend to exclude certain people who either had not children or other interests in such a prize. Thus, in some embodiments, the user will be given a choice of a cash prize or scholarship, etc.

The instant invention has potential to raise enormous amounts of money for the conductor of the lottery/sweepstakes. As a specific example, AT&T, according to some sources, has over 70 million subscribers. Assuming a very low participation rate (e.g., 10%), more than $7,000,000 a month could readily be generated using this method. Obviously, to the extent that the participation rate is higher the amount of money that will be generated will be correspondingly increased. The proceeds/profits from the lottery could either go to the corporation or, preferably, to a worthy cause of some sort.

In some embodiments, the additional money might be channeled back to the participants of the lottery at the end of the year or at some other time. For example, at the end of the year each participating customer could receive back some credit percentage of the amount that was tendered during the previous year to be applied towards a future bill. Depending on the way the lottery/sweepstakes is conducted, it is certainly possible that the money paid in by the participants could essentially be fully refunded with the prize money being taken from the interest that the entry money generated during the year. In such an instance, and depending on the economics of the lottery and other factors, such a lottery/sweepstakes might essentially be “free” to the participants in that the majority of the money that was tendered during the previous year could be returned to them at the end of the year.

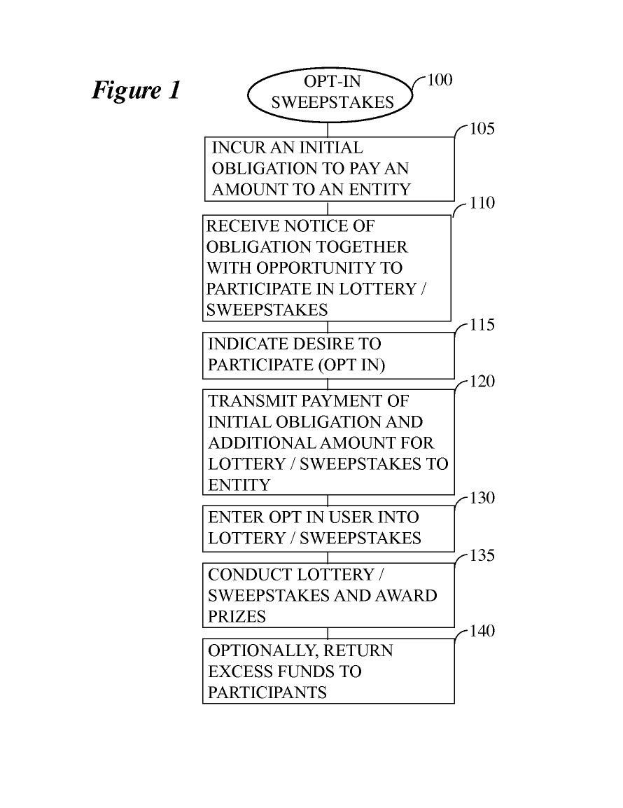

FIG. 1 contains an operating logic suitable for use with the instant invention 100. As an initial step, the user will incur an initial obligation to pay an amount to some entity (step 105). As is typically done, the user will eventually receive notice from the entity or its billing representative that such an obligation is owed. Additionally, and together with a notice of an obligation to pay, will be an opportunity to participate in a lottery/sweepstakes (step 110). In many embodiments, the notice of an obligation will take the form of a billing statement.

Along with the billing statement, the user will be presented with the opportunity to participate or opt in to the lottery. In some cases, this option will be presented via a check box or other field on the billing statement itself. The user might respond to same by inking in a check mark across in the appropriate field (step 115) and transmitting the form that indicates the desire to participate back to the entity that is designated to receive the payment (step 120). It should be clear that, if the user does not opt in to the instant lottery or sweepstakes, only the initial obligation will be sent to the collecting entity.

Assuming that the user has desired to opt in, that user will then be entered into the lottery or sweepstakes (step 130). In some embodiments, the user will receive a single entry based on the opt-in notice. In other embodiments, the user might receive multiple entries depending, for example, on the size of the initial obligation (e.g., if the user opts in, an initial obligation of $50 would become $51 and the user might then get 50 chances to win the lottery or sweepstakes). Those of ordinary skill in the art will readily understand how alternative schemes could be implemented.

Next, and as it is sometimes conventionally done, the lottery or sweepstakes will be conducted, winners will be designated, and prizes will be awarded (step 135).

Finally, and optionally according to some embodiments, any excess funds that have been generated by the lottery/sweepstakes will be returned to the opt-in participants (step 140). In some variations, this might be in the form of a credit on the participants' bills. In other embodiments, this might be in the form of cash or some other consideration.

It should be noted that, for purposes of the instant disclosure, that the terms “lottery” and “sweepstakes” will be interpreted to be interchangeable and have the same meaning: use of one term will automatically implicate the other.

It should be further noted and remembered that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility.

Additionally, although the instant disclosure has discussed submission of an indicia to indicate a willingness to participate to the entity that is sponsoring the lottery/sweepstakes, in reality often such a submission might be handled by one or more intermediaries, contractors, or other non-affiliated entities. As such, when the term “entity” is used herein, that term should be broadly interpreted to include the possibility that the entirety might be different legal entities that are cooperating together to implement the lottery/sweepstakes.

Further, it should be understood that in some embodiments, participants in the instant lottery/sweepstakes might be combined with others who, for example, might have paid separately to join. As an example, in some embodiments participants who entered via the opt-in provisions discussed herein might be automatically included in a larger, e.g., state, lottery. Thus, in some embodiments the winner that is drawn might be from among the opt-in participants or not.

Thus, the present invention is well adapted to carry out the objects and attain the ends and advantages mentioned above as well as those inherent therein. While presently preferred embodiments have been described for purposes of this disclosure, numerous changes and modifications will be apparent to those of ordinary skill in the art.

What is claimed is:

1. A method of conducting a sweepstakes, the method comprising:
(a) incurring by a user an initial obligation to pay an amount to an entity;
(b) providing to the user an opportunity to increment said initial obligation by an additional amount in order to be a participant in said sweepstakes;
(c) signaling an acceptance of said opportunity by submitting an indicium of said acceptance to the entity;
(d) receiving by the entity said indicium from the user;
(e) receiving by the entity a payment of said initial obligation and said additional amount;
(f) upon receipt of said indicium and said payment, entering the user into said sweepstakes;
(g) performing steps (a) through (f) until a plurality of different users have been entered into said sweepstakes;
(h) drawing at least one winner from among said users entered into said sweepstakes; and,
(i) awarding each of said at least one drawn winner a prize, thereby conducting said sweepstakes.

2. The method according to claim 1, wherein said initial obligation is selected from the group consisting of an electric bill obligation, a water bill obligation, a phone bill obligation, a gas bill obligation, and a cable bill obligation.

3. The method according to claim 1, wherein step (a) comprises the step of incurring on a monthly basis an initial obligation to pay an amount to an entity.

4. The method according to claim 1, further comprising the steps of:
(j) determining an amount of expenses associated with conducting said sweepstakes;
(k) determining an amount of proceeds from said sweepstakes; and,
(l) returning at least a portion of the difference between said amount of expenses and said amount of proceeds to said users entered into said sweepstakes.

5. The method according to claim 1, wherein the user is notified of said initial obligation to pay an amount by a printed statement, and wherein step (b) comprises the step of:
(b1) providing to the user an opportunity to increment said initial obligation by an additional amount in order to be a participant in said sweepstakes, said opportunity to increment said initial obligation being provided by an opt-in field on said statement.

6. The method according to claim 5, wherein step (c) comprises the step of:
(c1) marking by the user within said opt-in field on said statement and mailing said marked statement to the entity, thereby signaling acceptance of said opportunity.
(c) signaling an acceptance of said opportunity by submitting an indicium of said acceptance to the entity;

7. A method of conducting a sweepstakes, the method comprising:
(a) incurring by a user an obligation to pay an amount to an entity;
(b) receiving by the user a notification of said obligation to pay;
(c) after receipt of said notification, paying by the user of the amount plus an additional amount to the entity in consideration of being entered into the sweepstakes;
(d) performing steps (a) through (c) until a plurality of different users have paid the additional amount to enter said sweepstakes;
(e) drawing at least one winner from among said users entered into said sweepstakes; and,
(f) awarding each of said at least one drawn winner a prize, thereby conducting said sweepstakes.

8. The method according to claim 7, wherein said obligation is selected from the group consisting of an electric bill obligation, a water bill obligation, a phone bill obligation, a gas bill obligation, and a cable bill obligation.

9. The method according to claim 7, wherein step (a) comprises the step of incurring by the user on a monthly basis an obligation to pay an amount to the entity.

10. The method according to claim 7, further comprising the steps of:
(g) determining an amount of expenses associated with conducting said sweepstakes;
(h) determining an amount of proceeds from said sweepstakes; and,
(i) returning at least a portion of the difference between said amount of expenses and said amount of proceeds to said users entered into said sweepstakes.
